(19) United States
(12) Patent Application Publication
(10) Pub. No.: US 2025/0376134 A1
(43) Pub. Date: Dec. 11, 2025

(54) TRAILER SNOW ICE REMOVAL APPARATUS

(71) Applicant: EDDYNET INC., Danville (CA)

(72) Inventors: René Bellerose, St-Rémi-de-Tingwick (CA); Sébastien Gagnon, Victoriaville (CA)

(21) Appl. No.: 19/225,905

(22) Filed: Jun. 2, 2025

Related U.S. Application Data
(60) Provisional application No. 63/657,455, filed on Jun. 7, 2024.

(51) Int. Cl. B60S 3/06

(52) U.S. Cl. CPC B60S 3/066

(57) ABSTRACT

An apparatus is for removing ice and snow from a vehicle moving along a vertical vehicle driving plane. The apparatus has a scaffolding, and a carriage mounted thereto for raising and lowering a sweeping system. The sweeping system is mounted to the carriage cantilever to the scaffolding, for accessing the vehicle from above. The sweeping system has a member, wheels rotatably mounted thereto oblique to the vehicle driving plane, and a motor driving the wheels. Each wheel has rotatable brackets mounted thereto, with sweeping assemblies mounted thereto, with the sweeping assemblies coupling the wheels. Each of the sweeping assemblies are made of a shaft and sweeping components mounted thereto. Rotation of the wheels drives the sweeping assemblies in a circular motion oblique to the vehicle driving plane, with the sweeping components breaking the ice when lowering and sweeping the ice and snow out of the roof of the vehicle.

### CROSS-REFERENCE TO RELATED APPLICATION

This application relates to and is a non-provisional application claiming priority under 35 U.S.C. § 119(e) and 37 C.F.R. § 1.78(a) for a priority claim to earlier-filed provisional application Ser. No. 63/657,455, filed Jun. 7, 2024, under 35 U.S.C. § 111, entitled TRAILER SNOW ICE REMOVAL APPARATUS, the specification of which is hereby incorporated herein by reference in its entirety.

### BACKGROUND

### (a) Field

The subject matter disclosed generally relates to apparatus for cleaning vehicles. More particularly, the subject matter disclosed relates to apparatus for removing snow and ice from vehicle, and particularly from trucks and semi-trailers.

### (b) Related Prior Art

In the field of vehicles, in cold climate, ice and snow accumulate on the vehicle, mostly on top horizontal surfaces, and must be removed, for safety reasons, before driving the vehicle. Should the vehicle get on the road with ice and snow on top, the snow and ice can fly off the top of the vehicle and become a hazard for following vehicles.

With trucks and semi-trailers, and other similar large or oversized vehicles, it is difficult for one person to remove ice and snow accumulated on the roof manually. Furthermore, it takes significant time, is an uncomfortable task, risks to damage the vehicle or injure the worker since needing to be performed when the temperature is under the freezing temperature with a top surface that could be slippery.

There is therefore a need for a more automatized solution to remove ice and snow from the roof of oversized vehicle.

### SUMMARY

According to an embodiment, there is provided an apparatus for removing ice and snow from a vehicle, the apparatus moving along a vertical vehicle driving plane while the vehicle moves forward slowly to clear the length of the vehicle. The apparatus has a scaffolding, and a carriage mounted thereto for raising and lowering a sweeping system. The sweeping system is mounted to the carriage cantilever to the scaffolding, for accessing the vehicle from above. The sweeping system has a member, wheels rotatably mounted thereto oblique, in the illustrated embodiments, to the vehicle driving plane, and a motor driving the wheels. Each wheel has rotatable brackets mounted thereto, with sweeping assemblies mounted thereto, with the sweeping assemblies coupling the wheels. Each of the sweeping assemblies are made of a shaft and sweeping components mounted thereto. Rotation of the wheels drives the sweeping assemblies in a circular motion oblique to the vehicle driving plane, with the sweeping components breaking the ice when lowering and sweeping the ice and snow out of the roof of the vehicle.

In some aspects, the description herein relates to a removal apparatus for removing ice and snow from a vehicle, the removal apparatus including: a member; a first wheel mounted to the member, the first wheel being rotatable around a first wheel rotation axis, and a second wheel mounted to the member distant to the first wheel, the second wheel being rotatable around a second wheel rotation axis, the first wheel rotation axis and the second wheel rotation axis being parallel while non-coaxial with one another; a plurality 1, further including a plurality of A-brackets mounted to the first wheel and a plurality of B-brackets mounted to the second wheel, each of the A-brackets and the B-brackets being rotatable around a bracket rotation axis, wherein at least one of the sweeping assemblies is mounted to a first one of the A-brackets and a first one of the B-brackets.

In some aspects, the description herein relates to a removal apparatus, wherein at least one of the sweeping assemblies includes a shaft and at least one sweeping component mounted to the shaft.

In some aspects, the description herein relates to a removal apparatus, wherein at least one of the sweeping assemblies includes a shaft and at least two sweeping components mounted to the shaft, the at least two sweeping components extending parallel to one another.

In some aspects, the description herein relates to a removal apparatus, wherein at least one of the sweeping assemblies is mounted to the first A-bracket and the first B-bracket and hangs therefrom.

In some aspects, the description herein relates to a removal apparatus, wherein the at least one sweeping component includes one of a block of soft material, a block or rubber-made material, a block with bristles mounted thereto, a block including fibers mounted thereto, and a block including bands of textile.

In some aspects, the description herein relates to a removal apparatus, wherein the plurality of sweeping assemblies have a longitudinal axis, wherein the removal apparatus features a swaying angle measured between a) the first wheel rotation axis and b) the longitudinal axis of the sweeping assemblies, the swaying angle being at least forty (40) degrees.

In some aspects, the description herein relates to a removal apparatus, wherein the plurality of sweeping assemblies have a longitudinal axis, wherein the removal apparatus features a driving angle measured between a) the axis of the first wheel and b) an operating plane along which the removal apparatus operates, the driving angle being between five (5) and forty (40) degrees, the operating plane being a plane along which moves the vehicle or the member.

In some aspects, the description herein relates to a removal apparatus, wherein the plurality of sweeping assemblies have a longitudinal axis, wherein the removal apparatus features a sweeping angle measured between a) the longitudinal axis of the sweeping assemblies, and b) an operating plane along which the removal apparatus operates, the sweeping angle being between about thirty-five (35) and about eighty (80) degrees, the operating plane being a plane along which moves the vehicle or the member.

In some aspects, the description herein relates to a removal apparatus, further including a support structure, wherein the member is mounted to the support structure hanging therefrom.

In some aspects, the description herein relates to a removal apparatus, wherein the member is controllably orientable relative to an operative plane, the operating plane being a plane along which moves the vehicle or the member.

In some aspects, the description herein relates to a removal apparatus, wherein the support structure includes a counterweight.

In some aspects, the description herein relates to a removal apparatus, including a holding structure, wherein the support structure is mounted to the holding structure cantilevered relative thereto.

In some aspects, the description herein relates to a removal apparatus, including a holding structure including a scaffolding.

In some aspects, the description herein relates to a removal apparatus, wherein the support structure is movable non-parallelly to an operating plane, the operating plane being a plane along which moves the vehicle or the member.

In some aspects, the description herein relates to a removal apparatus, further including a holding structure, rails mounted to the holding structure, and a motorized carriage movable along the rails.

In some aspects, the description herein relates to a removal apparatus, wherein the removal apparatus is secured to the ground.

In some aspects, the description herein relates to a removal apparatus, wherein the A-brackets are rotatable relative to a first bracket axis along which the A-brackets are mounted to the first wheel, the A-brackets further including a second bracket axis along which the sweeping assemblies are mounted to the A-brackets.

In some aspects, the description herein relates to a removal apparatus, further including a first damper adapted to damp a change of position of the member.

In some aspects, the description herein relates to a removal apparatus, wherein further including a second damper operating opposingly to the first damper, wherein the first and second dampers bias the member into a default position.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a photograph of a truck close to an ice and snow removal apparatus;

FIG. 2 is a photograph of a truck hauling a semi-trailer, with an ice and snow removal apparatus cleaning the trailer from ice and snow;

FIG. 3A is a perspective view of an exemplary truck that may need removal of ice and snow of which the ice and snow removal apparatus described therein is adapted to;

FIG. 3B is a side view of an exemplary box truck that may need removal of ice and snow of which the ice and snow removal apparatus described therein is adapted to FIG. 4 is a side view from a first direction of an ice and snow removal apparatus in accordance with another embodiment;

FIG. 5 is a side view from a second direction of the ice and snow removal apparatus of FIG. 4;

FIG. 6 is a front view of the ice and snow removal apparatus of FIG. 4;

FIG. 7 is a rear view of the ice and snow removal apparatus of FIG. 4;

FIG. 8 is a plane elevated view of the ice and snow removal apparatus of FIG. 4;

FIG. 9 is a perspective view of the ice and snow removal apparatus of FIG. 4;

FIG. 10 is a perspective view of scaffolding of the ice and snow removal apparatus of FIG. 4 in accordance with an embodiment;

FIG. 11 is a left oblique perspective view of the raising system mounted to the scaffolding of the ice and snow removal apparatus of FIG. 4 in accordance with an embodiment;

FIG. 12 is a right oblique perspective view of the raising system mounted to the scaffolding of the ice and snow removal apparatus of FIG. 4 in accordance with an embodiment;

FIG. 13 is a front view of the sweeping system of the ice and snow removal apparatus of FIG. 4 in accordance with an embodiment;

FIG. 14 is a side view of the sweeping system of the ice and snow removal apparatus of FIG. 4 in accordance with an embodiment;

FIG. 15 is a perspective view of the sweeping system of the ice and snow removal apparatus of FIG. 4 in accordance with an embodiment;

FIG. 16 is a cross-section view of the sweeping assembly part of the sweeping system of the ice and snow removal apparatus of FIG. 4 along cross-section line -16- depicted in FIG. 14, in accordance with an embodiment;

FIG. 17 is a close-up view of the ice and snow removal apparatus of FIG. 4 along a first line of sight, depicting a portion of a wheel with sweeping devices coupled thereto; and

FIG. 18 is a close-up view of the ice and snow removal apparatus of FIG. 4 along a second line of sight, depicting a portion of a wheel with sweeping devices coupled thereto.

It will be noted that throughout the appended drawings, like features are identified by like reference numerals.

### DETAILED DESCRIPTION

The realizations will now be described more fully hereinafter with reference to the accompanying figures, in which realizations are illustrated. The foregoing may, however, be embodied in many different forms and should not be construed as limited to the illustrated realizations set forth herein.

With respect to the present description, references to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values and of values herein or on the drawings are not intended to be limiting, referring instead individually to any and all values falling within the range, unless otherwise indicated herein, and each separate value within such a range is incorporated into the specification as if it were individually recited herein. The words “about”, “approximately”, or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described realizations. The use of any and all examples, or exemplary language (“e.g.,” “such as”, or the like) provided herein, is intended merely to better illuminate the exemplary realizations and does not pose a limitation on the scope of the realizations. No language in the specification should be construed as indicating any unclaimed element as essential to the practice of the realizations. The use of the term “substantially” is intended to mean “for the most part” or “essentially” depending on the context. It is to be construed as indicating that some deviation from the word it qualifies is acceptable as would be appreciated by one of ordinary skill in the art to operate satisfactorily for the intended purpose.

In the following description, it is understood that terms such as “first”, “second”, “A”, “B”, “top”, “bottom”, “above”, “below”, and the like, are words of convenience and are not to be construed as limiting terms.

The terms “top”, “up”, “upper”, “bottom”, “lower”, “down”, “vertical”, “horizontal”, “interior” and “exterior” and the like are intended to be construed in their normal meaning in relation with normal installation of the ice and snow removal apparatus.

It should further be noted that for purposes of this disclosure, the term “coupled” means the joining of two members directly or indirectly to one another. Such joining may be stationary in nature or movable in nature. Such joining may allow for the flow of fluids, electricity, electrical signals, or other types of signals or communication between two members when power transmission or communication is involved. Such joining may be achieved with the two members, or the two members and any additional intermediate members being integrally formed as a single unitary body with one another or with the two members or the two members and any additional intermediate members being attached to one another. Such joining may be permanent in nature or alternatively may be removable or releasable in nature.

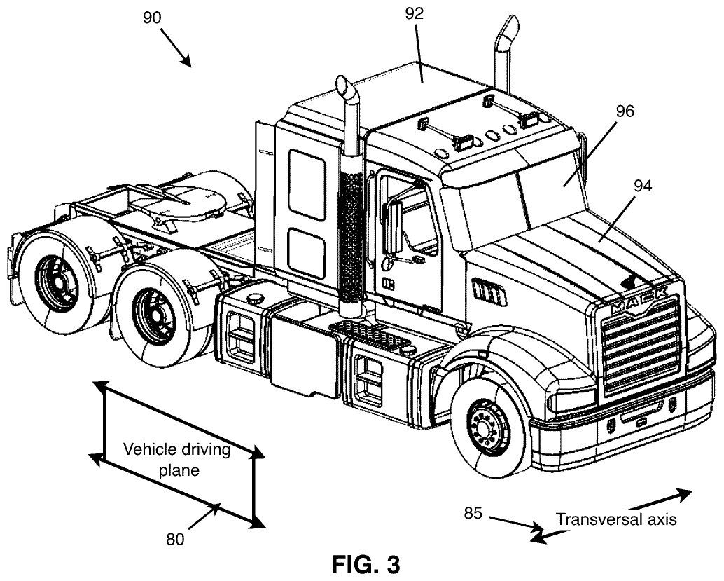

Referring now to FIG. 3A and FIG. 3B, it shows an exemplary truck 90 and an exemplary truck box truck 91 for the cleaning of which the ice and snow removal apparatus described therein is adapted to. In the present context, removal of ice and snow is intended to be performed on surfaces that are more favorable for ice and snow to fall thereon, and to accumulate thereon. These surfaces are, due to the size of the vehicle, difficult to reach by a driver, and are thus useful for an apparatus to perform the work.

In the present context of the exemplary truck 90, the roof 92, and e.g., the hood 94 and the windshield 96 are to be understood as surfaces to be potentially cleaned. For reference purpose, the vertical plane aligned with the longitudinal axis of the truck 90 is the vehicle driving plane 80, and the axis perpendicular to the vehicle driving plane 80 is the transversal axis 85.

In the context of a box truck 91, the hood 94, the windshield 96, and the roof 92 of the box truck 91 can be cleaned, as the roof 98 of the box 99.

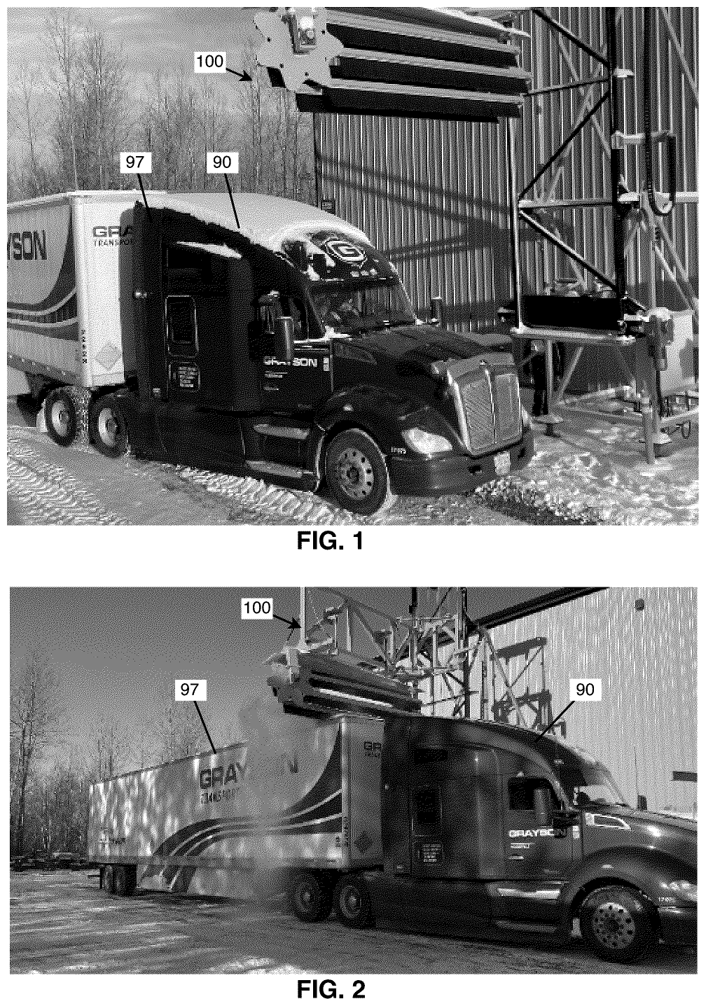

FIG. 1 and FIG. 2 depict a truck 90 hauling a semi-trailer 97. FIG. 1 depicts the truck approaching the snow and ice removal apparatus, hereinafter called removal apparatus. At this step, the sweeping assemblies 112 are raised above. FIG. 2 depicts later, with the truck 90 being driven while the removal apparatus 100 operates on the roof of the trailer 97

In case of other types of oversized vehicles such as semi-trailers (see FIG. 1 and FIG. 2), surfaces to be cleaned include or are potentially limited to the roof. Similar reference planes and axis apply to these other oversized vehicles, self-propelled or not.

Referring to FIG. 1 and FIG. 2, they depict a truck 90 hauling a semi-trailer 97. FIG. 1 depicts the truck 90 approaching the removal apparatus 100. At this step, the sweeping assemblies 112 are raised to a position above the highest elements of the truck 90. FIG. 2 depicts the cleaning operation at a later moment, with the truck 90 being driven while the removal apparatus 100 operates on the roof of the semi-trailer 97. The truck 90 hauling the semi-trailer 97 allows the cleaning to be performed over the whole length of the roof of the semi-trailer 97.

According to an embodiment, cargo containers may also be cleaned. According to an embodiment, the floor of flatbed semi-trailers or other cargo-enclosure-less semi-trailers may also be cleaned using the removal apparatus 100 when the operating height range of the removal apparatus includes the height of flatbed semi-trailers or other cargo-enclosure-less semi-trailers.

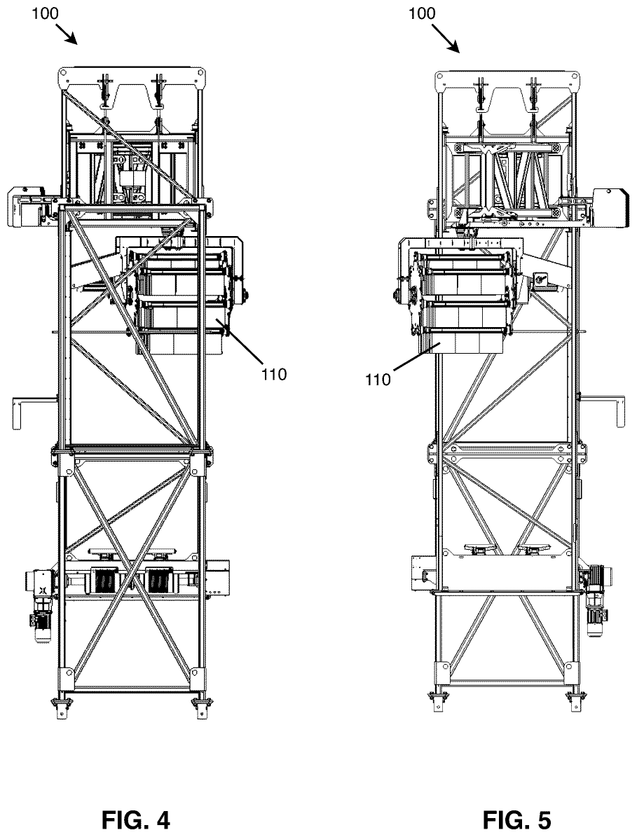

FIG. 4 and FIG. 5 are showing a removal apparatus 100 in accordance with another embodiment.

Removal of ice and snow is performed by contact and movement of bristles or soft blocks, hereinafter called sweeping components 110, on the surface of the body of the exemplary truck 90. The displacement of the sweeping components 110 includes vertical displacement towards to the surface to be cleaned, and horizontal movement of the sweeping components 110 oblique to the vehicle driving plane 80 in the illustrated embodiment. Alternate positioning of the sweeping component 110 could be possible and remain within the scope of the present application. Accordingly, for long surfaces and non-planar surfaces, ice and snow are pushed towards a side edge of the surface where it drops out of the surface, limiting the amount of ice and snow remaining on the surface to be cleaned by the removal apparatus 100.

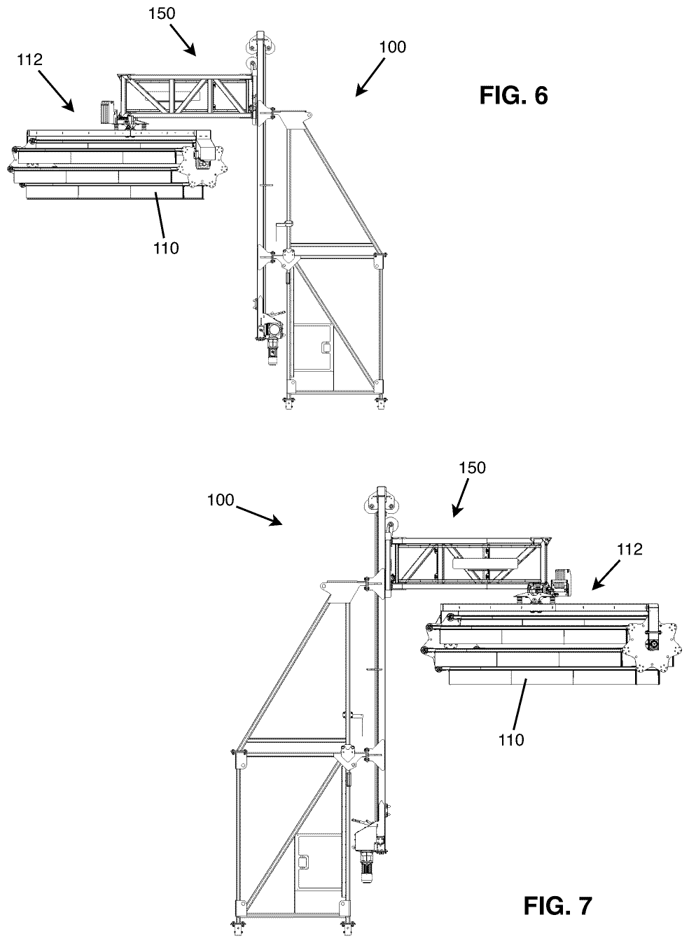

FIG. 6 and FIG. 7 show sideways the removal apparatus 100. In practice, the truck 90 advances aside the removal apparatus 100, and when under the sweeping assembly 112, the sweeping system 150 is activated and lowered until the sweeping components 110 contacts the body, breaking the surface of ice and snow on the surface to be cleaned. The distance between the sweeping components 110 and the surface to be cleaned can be managed by e.g., sensors sensing the pressure applied by the sweeping assemblies 112 on the vehicle (i.e., strength gages), optical sensors or other type of sensing means, alone or in combination. The rotation of the sweeping components 110 compels them to contact and travel on the surface to be cleaned, pushing the ice and snow out of the surface. The sweeping components 110 produces a vibration by producing a series of vertical contacts, or impacts on the vehicle's top surface that reverberate into the surface to be cleaned, that is often constructed with a material generally having a degree of flexibility, and that loosen ice from the surface that could be stuck on the vehicle. This is used in collaboration with the not completely rigid top surfaces of vehicles to detach ice.

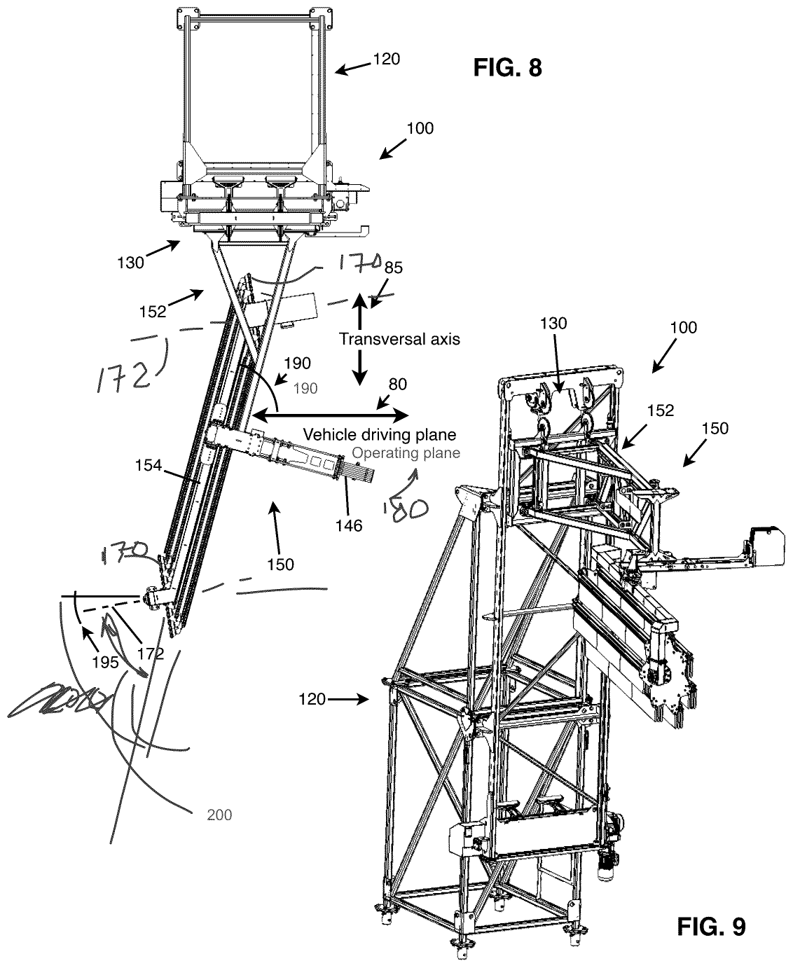

Referring additionally to FIG. 8 and FIG. 9, the removal apparatus 100 comprises a holding structure embodied as a scaffolding 120 secured to the ground and sized to provide structure for the sweeping system 150 to be raised above the exemplary truck 90. As the vehicle traveling side of the removal apparatus 100, a raising system 130 takes place for adjusting the height of the sweeping system 150. The sweeping system 150 is mounted to the raising system 130.

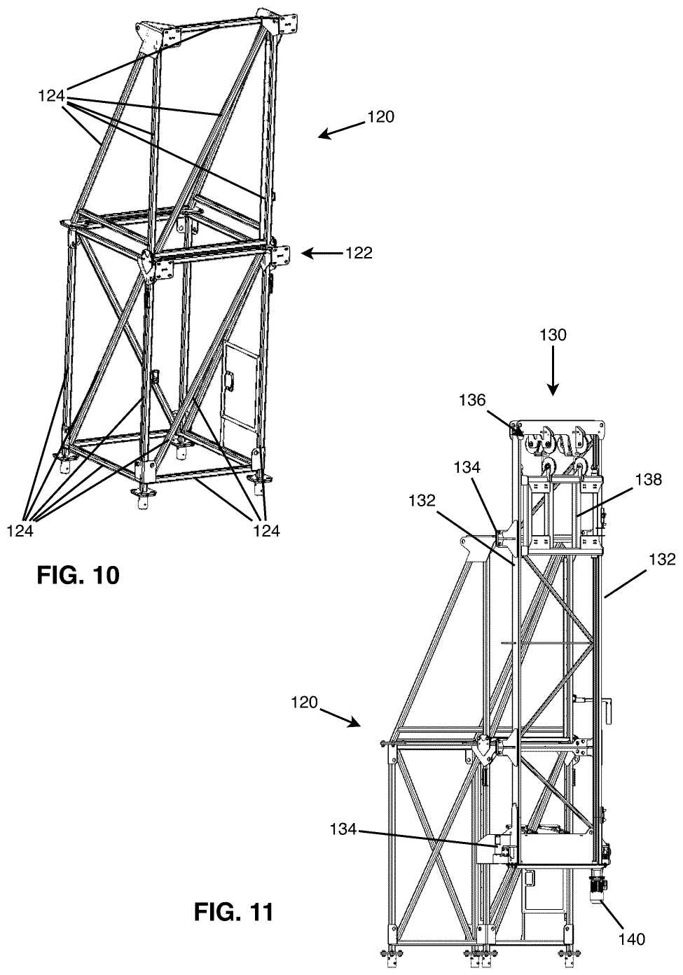

Referring particularly to FIG. 10, it shows the scaffolding 120 of the removal apparatus 100. The scaffolding 120 comprises a series of members 124 rigidly mounted to each other providing a generally free area 122 on the vehicle traveling side, and furthermore provided either or in combination counterweight and anchoring for the removal apparatus 100 to remain stable with the sweeping system 150 mounted in cantilever thereby being able to lay above the truck 90.

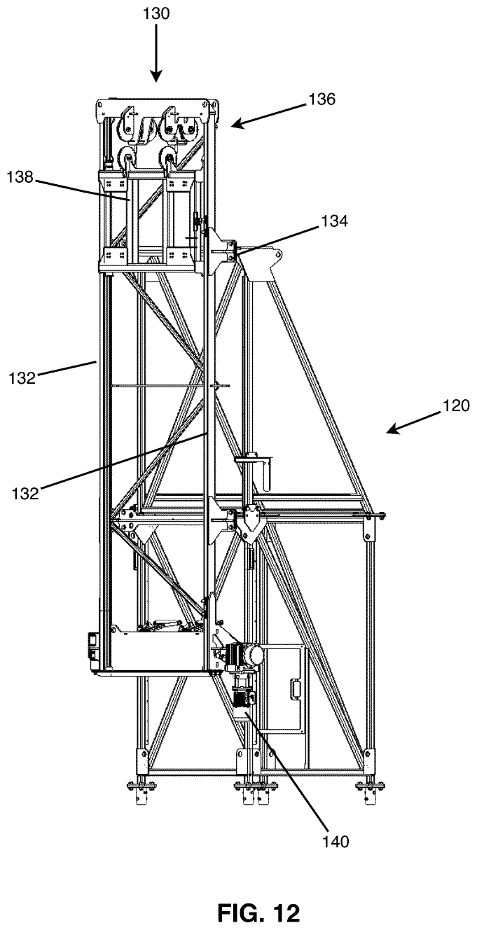

FIG. 11 and FIG. 12 show the raising system 130 mounted to the scaffolding 120 on the vehicle traveling side. The raising system 130 comprises a pair of guiding rails 132 adapted for a carriage 138 to travel along when being raised or lowered. The raising system 130 further comprising anchoring brackets 134 for mounting to the scaffolding 120. It comprises a pulley system 136 at its top connected to the carriage 138 adapted to travel along the guiding rails 132. A motor 140 coupled to the pulley system 136 is adapted to actuate the pulley system 136, thereby driving up and down the carriage 138.

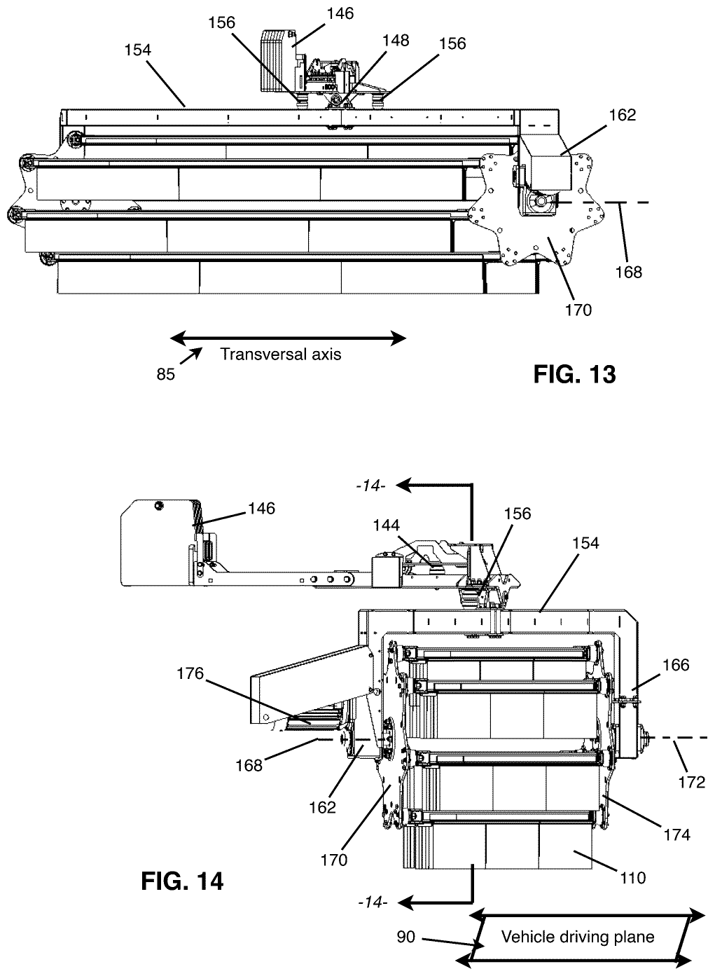

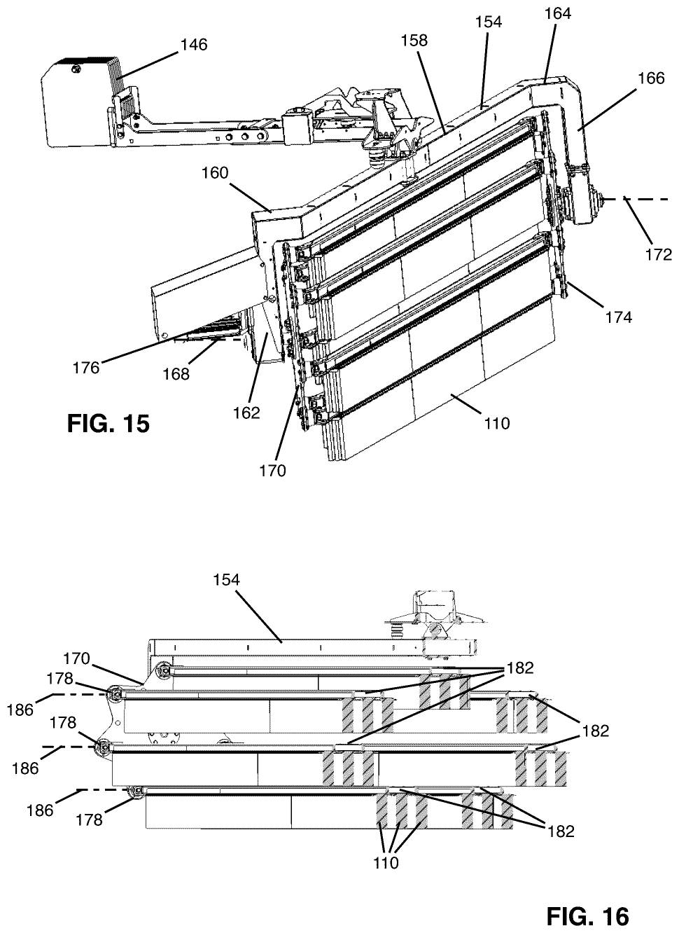

Referring to FIG. 9, FIG. 13, FIG. 14 and FIG. 15, the sweeping system 150 is mounted to the carriage 138 in a cantilever configuration through its support structure 152 depicted on FIG. 9. The sweeping system 150 further comprises a member 154 mounted substantially horizontal hanging from the support structure 152.

According to an embodiment, the member 154 is coupled to the support structure 152 through a central joint 148 and a pair of dampers 156 allowing the member 154 to slant slightly relative to a horizontal plane to adapt to the roof of the truck 90 being potential not horizontal.

According to an embodiment, a hanging joint 144 allows the member 154 to lower and raise in contact with the truck 90, with a counterweight 146 counteracting to balance the forces relative to the hanging joint 144.

The member 154 has a non-linear shape, comprising a central portion 158, a first oblique portion 160 extending rearwards relative to the central portion 158, and a first hanging portion 162 extending downwards from the first oblique portion 160. The first hanging portion 162 therefore extends toward the ground rearwards to a vertical plane following the central portion 158. Opposed to the first oblique portion 160, the member 154 comprises a second oblique portion 164 extending frontwards from the central portion 158, and a second hanging portion 166 extending downwards from the second oblique portion 164. The second hanging portion 166 therefore extends toward the ground frontwards to a vertical plane following the central portion 158.

A first wheel rotation axis 168 that extends horizontally from the first hanging portion 162, has a first wheel 170, or a wheel A, rotatably mounted thereto. A second wheel rotation axis 172, that extends horizontally from the second hanging portion 166, non-coaxial to the first wheel rotation axis 168, has a second wheel 174, or wheel B, rotatably mounted thereto. A motor 176 is coupled to the first wheel 170, driving the sweeping assemblies 112. Alternatively, a hydraulic or pneumatic actuator could be used.

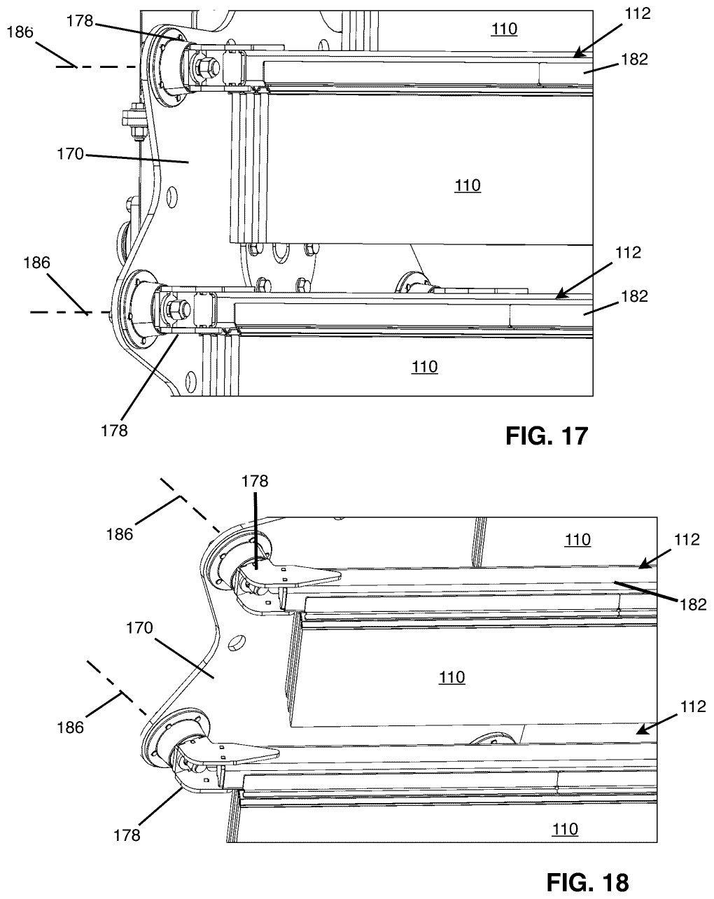

Referring additionally to FIG. 17 and FIG. 18, on the wheels 170, 174 are rotatably mounted a plurality of brackets 178, or A-brackets and B-brackets, located at corresponding positions respectively on the wheels 170 and 174. Each one of the brackets 178, A-brackets and B-brackets, is adapted to rotate individually over the surface of the corresponding wheel 170, 174 around to their own bracket rotation axis 186.

Shafts 182 are coupled to correspond brackets 178 on each wheel 170, 174, extending oblique to the planes of the wheels 170, 174, planes which are perpendicular to the wheel rotation axes 168, 172. Rotation of the wheels 170, 174 are forcing the brackets 178 to rotate around their bracket rotation axis 186, and forcing circular motion of the sweeping assemblies 112.

Movements of each of the sweeping assemblies 112 are as follows relative to the surface to be cleaned of the vehicle: A sweeping assembly 112 rotates downwards with the wheels 170, 174 turning. The sweeping components 110 of the sweeping assembly 112 hit the surface to be cleaned, breaking the ice and snow while generating vibration on the surface to be cleaned. The sweeping assembly 112 continues its path with the sweeping components 110 hanging from their shafts 182 being dragged over the surface to be cleaned, bent, moving in an oblique direction relative to the vehicle driving plane 80. When the shafts 182 of the sweeping components 110 raises after sweeping a portion of the surface to be cleaned, the sweeping components 110 hanging therefrom gradually raise and cease contact with the truck 90. The next sweeping assemblies 112 follows the same course, with its sweeping components 110 entering in contact with the truck 90 before the previous one ceases contact.

Accordingly, the sweeping system 150 generate a queue of sweeping assemblies 112 having their sweeping components 110 sequentially hitting the ice and snow and sweeping the ice and snow off the surface to be cleaned in a course oblique to the vehicle driving plane 80, in other words with component of the movement along the transversal axis 85 perpendicular to the vehicle driving plane 80 (see, inter alia, FIG. 3A, FIG. 3B and FIG. 8).

Distribution of the sweeping assemblies 112 and of the sweeping components 110 on the wheels 170, 174, of the removal apparatus 100 ensures that a plurality of sweeping components 110 may sweep at the same time the surface to be cleaned, a portion of the time with the sweeping components 110 actively sweeping being part of two distinct sweeping assemblies 112. Such configuration provides efficient vibration-inducing results, and ice and snow cleaning results.

According to embodiments, the sweeping assemblies 112 comprises a plurality of sweeping components 110, with each of the sweeping components 110 flexing at least partially independently, freely from sweeping components 110 next to them. Accordingly, bending limits of the sweeping components 110 may be configured, e.g., through design and/or material selection, or customized to adapt to the particular shapes of the vehicles they encounter.

According to an embodiment, the sweeping components 110 are made of one of block of soft material, rubber-made components, bristles, fibers, bands of textile, or another structure or material providing a required balance of flexibility and rigidity. According to embodiment, a combination thereof may be used.

According to a preferred embodiment, the sweeping components 110 are composed of assemblies of bristles of polypropylene since having a great resistance against abrasion and keeping a good flexibility characteristics at low temperatures such as minus 15 (−15) degrees Celsius. According to an embodiment, sweeping components 110 are made from AllPRO™ brushes of Keystone plastic.

The cross-section view of FIG. 16 shows that, according to an embodiment, sweeping assemblies 112 comprise a shaft 182, with three (3) layers of sweeping components 110, aka three (3) rows of sweeping components 110, mounted parallel to each other thereto. The sweeping components 110 are mounted one in front of the other, with similar dimension, and with a set clearance between each layer.

According to embodiments, more or less layers may be present. The sweeping assemblies 112 may feature layers of sweeping components 110 with gaps at some locations, with the gaps being at different locations depending on layers.

According to embodiments, alternative configurations may be used, such as rows of sweeping components 110 mounted slanted relative to the axis of the shaft 182, without departing from the scope of the present description.

FIG. 17 and FIG. 18 show a portion of a wheel 170 with brackets 178 mounted thereto. FIG. 18 shows that the brackets 178 are designed for the shafts 182 to be mounted thereto such that they extend oblique to the surface of the wheel 170. Sweeping components 110 are mounted to the shafts 182 hanging therefrom.

According to an embodiment, the sweeping angle 190 between a) the vehicle driving plane 80 and b) a longitudinal axis of the central portion 158 of the member 154 (and of the sweeping assemblies 112) is more than forty-five (45) degrees and less than ninety (90) degrees, preferably more sixty (60) degrees, and preferably about eighty (80) degrees.

According to an embodiment, the driving angle 195 between a) the vehicle driving plane 80 and b) the wheel rotation axes 168, 172 is more than five (5) degrees and less than forty (40) degrees, and preferably more than twenty (20) degrees and less than thirty (30) degrees, and preferably about twenty-four (24) degrees.

According to an embodiment, the swaying angle 200 between a) the first wheel rotation axis and b) the longitudinal axis of the sweeping assemblies, the swaying angle (200) is between at least forty (40) degrees, preferably at least fifty (50) degrees, and more preferably at least sixty (60) degrees.

According to an embodiment, at least one of the angles 190, 195, 200 is dynamically controllable.

According to an alternative embodiment, the removal apparatus 100 may be provided as an apparatus operating on e.g., an immobile vehicle. According to the latter embodiment, the member 154 moves along an operating plane 180 parallel to the vehicle driving plane 80 described before. In a more general sense, the operating plane 180 (identified in FIG. 8) is thus a plane along which moves the vehicle or the member, depending on the operation of the removal apparatus 100 requires displacement of the vehicle or the member 154.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A removal apparatus for removing ice and snow from a vehicle, the removal apparatus comprising:
a member;
a first wheel mounted to the member, the first wheel being rotatable around a first wheel rotation axis, and a second wheel mounted to the member distant to the first wheel, the second wheel being rotatable around a second wheel rotation axis, the first wheel rotation axis and the second wheel rotation axis being parallel while non-coaxial with one another;
a plurality of sweeping assemblies mounted to the first wheel and the second wheel; and
a motor driving least one of the first wheel and the second wheel,
wherein the plurality of sweeping assemblies are adapted to sequentially contact the vehicle as the first wheel and the second wheel rotate respectively around the first wheel rotation axis and the second wheel rotation axis.

2. The removal apparatus of claim 1, further comprising a plurality of first A-brackets mounted to the first wheel and a plurality of B-brackets mounted to the second wheel, each of the A-brackets and the B-brackets being rotatable around a bracket rotation axis, wherein at least one of the sweeping assemblies is mounted to a first one of the A-brackets and a first one of the B-brackets.

3. The removal apparatus of claim 1, wherein at least one of the sweeping assemblies comprises a shaft and at least one sweeping component mounted to the shaft.

4. The removal apparatus of claim 1, wherein at least one of the sweeping assemblies comprises a shaft and at least two sweeping components mounted to the shaft, the at least two sweeping components extending parallel to one another.

5. The removal apparatus of claim 2, wherein at least one of the sweeping assemblies is mounted to the first A-bracket and the first B-bracket and hangs therefrom.

6. The removal apparatus of claim 3, wherein the at least one sweeping component comprises one of a block of soft material, a block of rubber-made material, a block with bristles mounted thereto, a block comprising fibers mounted thereto, and a block comprising bands of textile.

7. The removal apparatus of claim 1, wherein the plurality of sweeping assemblies have a longitudinal axis, wherein the removal apparatus features a swaying angle measured between a) the first wheel rotation axis and b) the longitudinal axis of the sweeping assemblies, the swaying angle being at least forty (40) degrees.

8. The removal apparatus of claim 1, wherein the plurality of sweeping assemblies have a longitudinal axis, wherein the removal apparatus features a driving angle measured between a) the axis of the first wheel and b) an operating plane along which the removal apparatus operates, the driving angle being between five (5) and forty (40) degrees, the operating plane being a plane along which moves the vehicle or the member.

9. The removal apparatus of claim 1, wherein the plurality of sweeping assemblies have a longitudinal axis, wherein the removal apparatus features a sweeping angle measured between a) the longitudinal axis of the sweeping assemblies, and b) an operating plane along which the removal apparatus operates, the sweeping angle being between thirty-five (35) and eighty (80) degrees, the operating plane being a plane along which moves the vehicle or the member.

10. The removal apparatus of claim 9, wherein the member is controllably orientable relative to an operative plane, the operating plane being a plane along which moves the vehicle or the member.

11. The removal apparatus of claim 1, further comprising a support structure, wherein the member is mounted to the support structure hanging therefrom.

12. The removal apparatus of claim 11, wherein the support structure comprises a counterweight.

13. The removal apparatus of claim 11, comprising a holding structure, wherein the support structure is mounted to the holding structure cantilevered relative thereto.

14. The removal apparatus of claim 11, comprising a holding structure comprising a scaffolding.

15. The removal apparatus of claim 11, wherein the support structure is movable non-parallelly to an operating plane, the operating plane being a plane along which moves the vehicle or the member.

16. The removal apparatus of claim 1, further comprising a holding structure, rails mounted to the holding structure, and a motorized carriage movable along the rails.

17. The removal apparatus of claim 1, wherein the removal apparatus is secured to the ground.

18. The removal apparatus of claim 1, wherein the A-brackets are rotatable relative to a first bracket axis along which the A-brackets are mounted to the first wheel, the A-brackets further comprising a second bracket axis along which the sweeping assemblies are mounted to the A-brackets.

19. The removal apparatus of claim 1, further comprising a first damper adapted to damp a change of position of the member.

20. The removal apparatus of claim 19, wherein further comprising a second damper operating opposingly to the first damper, wherein the first and second dampers bias the member into a default position.
